(19) United States
(12) Patent Application Publication
(10) Pub. No.: US 2002/0182374 A1
(43) Pub. Date: Dec. 5, 2002

(54) Lamination method of embedding passive components in an organic circuit board

(76) Inventor: I-Chung Tung, Hsinchu (TW)

Correspondence Address: Raymond Sun, 12420 Woodhall Way, Tustin, CA, 92782, US

(21) Appl. No.: 10/104,975

(22) Filed: Mar. 22, 2002

(30) Foreign Application Priority Data
Jun. 1, 2001 (TW) 90113288

(51) Int. Cl. B32B 1/06

(52) U.S. Cl. 428/182; 156/81; 156/213

(57) ABSTRACT

A method for fabricating an organic circuit board having embedded passive components, such as resistors, capacitors and inductors, is disclosed. In embedding a resistor or capacitor, a passive unit of a resistive film or a capacitive film is first made on one side of a conductive foil. In forming an inductor, a soft magnetic film is first made on one side of a conductive foil. The foil with the soft magnetic film is then introduced into the multilayer circuit board processing. The electrodes for various passive components or spiral coils for the inductive components and electrical circuit pattern are finally made on the same conductive foil simultaneously. The soft magnetic film deposited on the top of the spiral coil may be made to further improve inductor performance.

### BACKGROUND OF THE INVENTION

1. Field of the Invention

This invention relates generally to a lamination method of embedding passive components in an organic circuit board, and in particular, to a lamination method of an excellent uniformity of electrical properties of the passive components, and which particularly presents high reliability.

2. Brief Description of the Related Art

With an increasing tendency towards high performance and compact size, a circuit board is required to have a high degree of lamination and high density. In order to minimize the space requirements on circuit boards, the embedded passive components, such as resistors, capacitors, and inductors, in a multilayer circuit have been developed.

Integrating a variety of passive components in a multilayer circuit board can be accomplished in a number of ways. For instance, for thick-film resistor materials, such as a dispersion of silver powder or carbon particles in a resin or a dispersion of RuO₂ and glass powders in a binder, the thick-film resistor can be made by the screen printing method. A thin-film resistor material is composed one of the followings: Ni—Cr, Ni—P, Ni—Sn, Cr—Al, and TaN alloys, etc., and the thin-film resistors can be formed by one of sputtering, electroplating and electroless plating. The selection of thick-film resistors or thin-film resistors to be used in making a multilayer circuit board is a trade-off of cost and fine component resolution.

A number of methods to fabricate one of thick-film and thin-film for making passive components are well recognized. Currently, the critical issue is how to integrate the existing thick-film or thin-film passive components into the circuit board, which must be easily adaptable to the manufacture processing of a multiplayer circuit board. Most of the methods in this field, such as those provided by U.S. Pat. No. 3,857,683, 5,243,320, and 5,683,928, made the thick film or thin film passive components on the surface of the insulative layer by the screen printing and/or photoresist-etching method before stacking a new layer in the process of manufacturing a multilayer circuit board. In those methods, such as the metal Cu circuit pattern and the Cu electrodes for the passive components can not be formed by the same photoresis-etching step. Also, the electrical properties are not uniform due to uneven surface of the underlying insulative layer.

### SUMMARY OF INVENTION

It is therefore an object of the present invention to provide a lamination method of embedding passive components in an organic circuit board, which features excellent uniformity of electrical properties of the passive components, and which particularly presents high reliability.

Another object of this invention is to adopt a process of making the film-type passive components, such as resistors, capacitors, and inductors, which is easily adaptable to the multilayer circuit board manufacture.

A further object of the present invention is providing the precise film type passive components embedded in a multilayer circuit board, whose high reliability property is still maintained.

A further object of the present invention is providing a film-type resistor that is embedded in a multilayer circuit board, wherein a resistive film is first made on a surface of a conductive foil and then laminated onto a unit circuit sheet using an insulative layer as an adhesive layer. The electrodes for the resistive film and circuit pattern are formed on the same layer of the conductive foil. The unit circuit sheet comprises the insulative layer(s) made of an epoxy resin, polyimide, bismeleimide triazine, cyanate ester, polybenzocyclobutene and the like, and at least one side of the unit circuit sheet is covered with a patterned thin conductive layer made of a conductive material, such as metal, conductive polymers, hardened metal paste or hardened carbon paste.

A further object of the present invention is providing a film-type capacitor which is embedded in a multilayer circuit board, wherein a capacitive film covered with a conductive layer being an electrode for the capacitor is first made on a surface of a conductive foil and then laminated onto a unit circuit sheet using an insulative layer as an adhesive layer. The other electrode for the capacitive film and circuit pattern are formed on the same layer of the conductive foil. The unit circuit sheet comprises the insulative layer(s) made of an epoxy resin, polyimide, bismeleimide triazine, cyanate ester, polybenzocyclobutene and the like, and at least one side of the unit circuit sheet is covered with a patterned thin conductive layer made of a conductive material, such as metal, conductive polymers, hardened metal paste or hardened carbon paste.

A further object of the present invention is providing an inductor which is embedded in a multilayer circuit board, wherein a soft magnetic film is deposited on the surface of a conductive foil and then laminated onto a unit circuit sheet using an insulative layer as an adhesive layer. The spiral coil being an inductive element and circuit pattern are formed on the same layer of the conductive foil. The other soft magnetic film may be deposited and covers the spiral coil, if necessary. The unit circuit sheet comprises the insulative layers made of an epoxy resin, polyimide, bismeleimide triazine, cyanate ester, polybenzocyclobutene and the like, and at least one side of the unit circuit sheet is covered with a patterned thin conductive layer made of a conductive material, such as metal, conductive polymers, hardened metal paste or hardened carbon paste.

Other features and advantages of the invention will become apparent from the following description of a preferred embodiment taken in conjunction with the accompanying drawings.

### BRIEF DESCRIPTION OF THE DRAWINGS

FIGS. 1 to 2 are cross-section views showing the lamination method of embedding passive components in an organic circuit board with film-type resistors in accordance with one embodiment of the present invention.

FIG. 3 is a cross-section view showing the structure of conductive foil with a matte surface, a surface, and a less rough area, where the resistive film will be deposited accordance with one embodiment of the present invention.

FIGS. 4 to 5 are cross-section views showing the laminate multilayer circuit board with film-type capacitors accordance with other embodiment of the present invention.

FIGS. 6 to 8 are cross-section views showing the laminate multilayer circuit board with film-type inductor in accordance with other embodiment of the present invention.

FIG. 9 is a cross-section view showing the laminate four-layer circuit board with film-type inductor in accordance with other embodiment of the present invention.

FIG. 10 is a cross-section view showing the laminate multilayer circuit board with protective layer in accordance with other embodiment of the present invention.

### DETAILED DESCRIPTION OF A PREFERRED EMBODIMENT

For a better understanding on the advantages and capabilities of the present invention, reference is made to the following disclosure, appended claims in connection with the accompany drawings. It is obvious to one skilled in the art that the principle feature of the invention may be employed in various embodiments without departing from the scope of the invention.

The invention provides a method to manufacture a high reliability multilayer circuit board having embedded passive components, wherein an insulative sheet is used as an adhesive for further stacking a conductive foil which carries passive units. The passive units, such as resistive films, capacitive films, and soft magnetic films, are first made on one side of the conductive foil. The foil with the passive units is introduced into the multilayer circuit board lamination process. After lamination, the circuit pattern and electrodes for the passive components are finally formed on the same conductive foil at the same time, which beneficially simplifies the process of embedding the passive components in a multilayer circuit board.

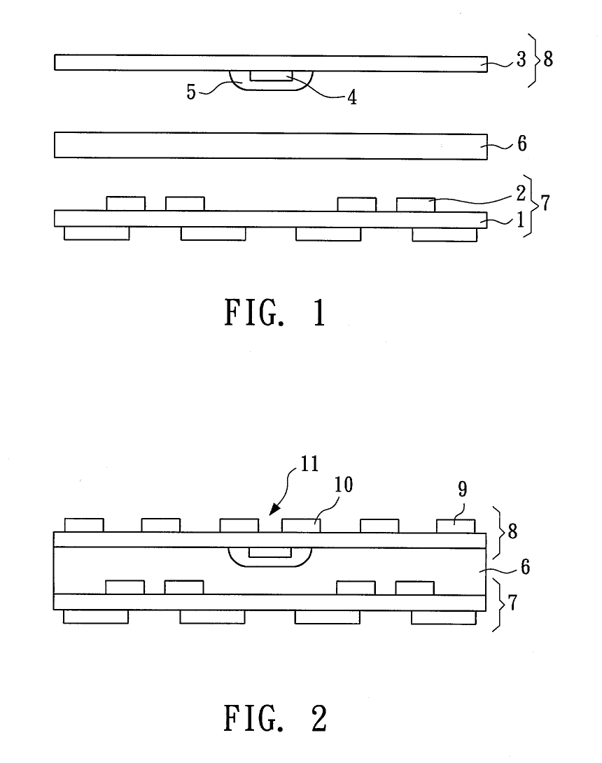

Now referring to FIG. 1, in accordance with a preferred embodiment of the present inventive process to embed resistors in a circuit board, there is initially provided an insulative layer 1 made of an epoxy resin, polyimide, bismeleimide triazine, cyanate ester, or polybenzocyclobutene and the like, covered with a patterned thin conductive layer 2 made of a conductive material, such as metal, conductive polymers, hardened metal paste or hardened carbon paste, etc. A conductive foil 3 which is composed one of the followings: copper, aluminum, silver, platinum, palladium, silver-palladium, etc., has the flat or slightly roughened surfaces on its double sides, and a resistive film 4 is deposited and may be hardened in place by heating on its bottom surface if necessary. A protective coating 5, which may be an insulative resin or ceramic material, such as epoxy resin, polyimide, bismeleimide triazine, cyanate ester, aluminum oxide, glass and 5 the like, is dispensed and covers said resistive film 4. Said protective coating 5 can be made by sputtering, printing or roll coating etc., which is well known in the art. If said protective coating 5 is made of resin, it would be much better processed a partial crosslinking reaction before the lamination process. Said conductive foil 3 containing said resistive film 4 is then surface roughened chemically or physically, which has been a well-known technique in the art. Then, an insulative sheet 6 composed one of the epoxy resin, bismeleimide triazine, and fiber reinforced epoxy resin is placed between the unit circuit sheet 7, which comprises said insulative layer 1 covered with a conductive layer 2, and the component-carrying conductive foil 8 comprising said conductive foil 3 with said resistive element 4. By pressing and heating, said foil 8 is laminated onto said unit circuit sheet 7. The alignment during this lamination step can be critical to success of the method. Through etching process, the circuit pattern 9 and the electrodes 10 are defined, as illustrated in FIG. 2, which beneficially simplifies the process of embedding the resistive components in a multilayer circuit board. The formation of a resistor component 11 embedded in a circuit board is thus accomplished.

Said electrical resistive film 4 may be made by electroplating, electroless plating, sputtering, roller coating or printing, etc. For instance, said resistive film made of Ni—Cr, Ni—Sn, Ni—P, Cr—Al or Ta—N alloy etc. can be electrodeposited or sputter-deposited, while carbon paste, Ag paste, or RuO₂-glass paste can be deposited by the printing methods. However, the above printed film should be hardened by curing (for carbon or Ag paste) or firing (for RuO₂-glass paste) in an ambient or inert atmosphere before the deposition of said protective coating 5.

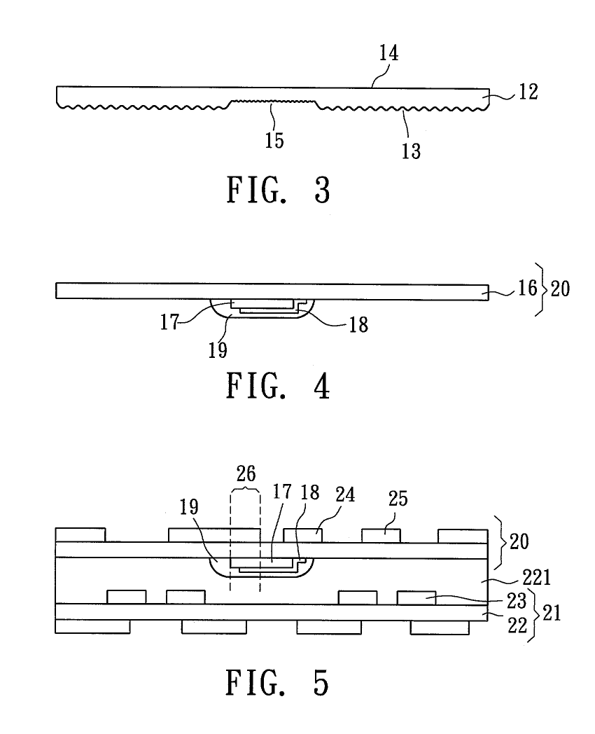

As illustrated in FIG. 3, the conductive foil 12 with a matte surface 13 and a surface 14, which may be either matte or flat, can also be used in accordance with the present invention. However, a less rough area 15, where the resistive film will be deposited, may be created such as by a photoresist-microetching process or polishing process. In such a case, said less rough area 15 can be used to create a more precise resistive film 4 having a predetermined value and further maintain a sufficient adhesion between the resistive film 4 and said conductive foil 12 simultaneously. In addition, said protective coating 5 becomes unnecessary because the surface roughening step for enhancing adhesion between the resistive film 4 and said conductive foil 12 can be skipped.

Referring next to FIG. 4, a capacitive film 17 is deposited on a flat or slightly roughened surface of the conductive foil 16, which can be made of copper, aluminum, silver, platinum, palladium, or silver-palladium, etc. Said capacitive film 17 may be hardened in place by heating if necessary. A conductive film 18 acting as a lower electrode such as copper, aluminum, silver, gold, platinum, palladium, conductive polymer, hardened carbon paste, or hardened silver paste etc., is deposited and partial covers said capacitive film 17. A protective coating 19, which may be an insulative resin or ceramic material, such as epoxy resin, polyimide, bismeleimide triazine, cyanate ester, aluminum oxide, glass and the like, is deposited and fully covers said capacitive film 17 and conductive film 18. If said protective coating 19 is made of resin, which is preferably partial crosslinked before the lamination process. As illustrated in FIG. 5, the component-carrying conductive foil 20, which comprises said conductive foil 16 carrying said capacitive film 17, is laminated onto a unit circuit sheet 21 using an insulative sheet 221 as the adhesive layer. The alignment must be carefully controlled during this lamination step. Said unit circuit sheet 21 comprises an insulative layer 22 made of an epoxy resin, polyimide, bismeleimide triazine, cyanate ester, or polybenzocyclobutene and the like, covered with a patterned thin conductive layer 23 made of a conductive material, such as metal, conductive polymers, conductive polymer, hardened metal paste or hardened carbon paste. Said insulative layer 22 may be organic material, such as epoxy resin, bismeleimide triazine, polyimide, or polybenzocyclobutene, etc., or organic material filled with fillers, such as fiber reinforced epoxy resin, particle silica filled epoxy resin, etc. The upper electrodes 24 and circuit pattern 25 are made on said conductive layer 16, which beneficially simplifies the process of embedding the capacitive components in a multilayer circuit board. The overlap region 26 of said electrodes 18 and 24 inherently defines the effective capacitive area.

Said capacitive film 17 which is a high dielectric constant material with a dielectric constant greater than 5.0 may be made by sputtering, roller coating or printing, etc. For instance, said capacitive film 17 made of barium titanate, lead-zirconate-titanate or amorphous hydrogenated carbon etc. can be sputter-deposited, while barium titanate-resin paste, e.g. barium titanate powders dispersed in a epoxy resin, or barium titanate-glass paste, e.g. containing barium titanate and glass powders dispersed in an organic vehicle, can be deposited by the printing methods. However, the above printed film should be hardened in place by curing (for barium titanate-resin paste) or firing (for barium titanate-glass paste) in an ambient or inert atmosphere before the deposition of said protective coating 19.

In accordance with the present invention, as illustrated in FIG. 3, the capacitive film 17 can also be deposited on a conductive foil 12 with a matte surface 13 and a surface 14, which may be either matte or flat. The less rough area 15, where the capacitive film 17 will be deposited, should be created, e.g. by a photoresist-microetching process or polishing process. In such a case, said less rough area 15 can be used to create a more precise capacitive film 17 having a predetermined value and further maintain a sufficient adhesion between the capacitive film 17 and said conductive foil 12 simultaneously. In addition, said protective coating 19 will be unnecessary because the surface roughening step for enhancing adhesion between the capacitive film 17 and said conductive foil 12 can be skipped. As an alternative configuration, both said soft magnetic film 26 and protective coating 28 may be skipped simultaneously.

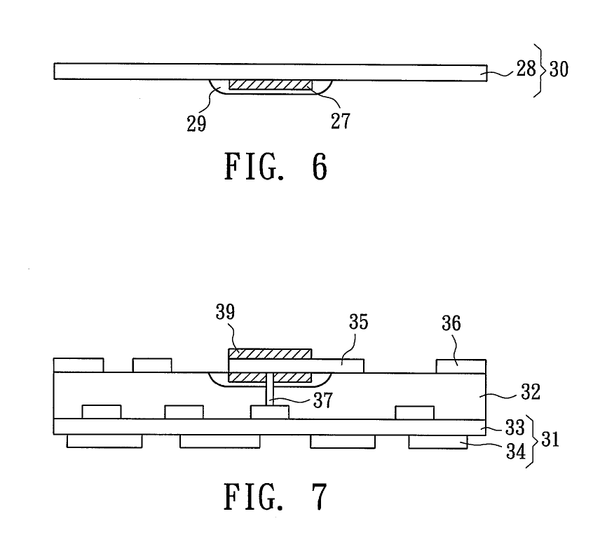

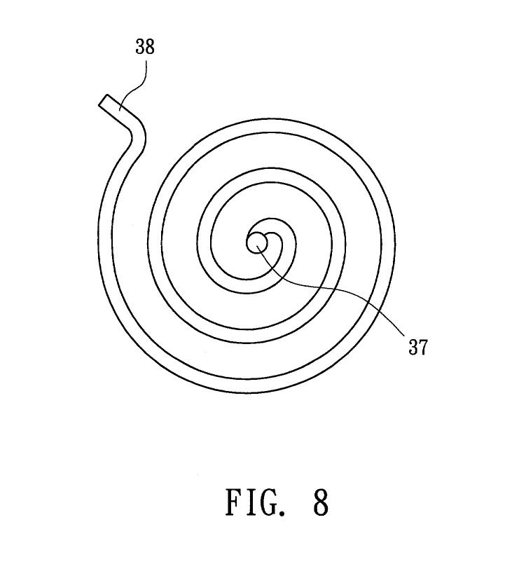

Referring next to FIG. 6, a soft magnetic material film 27 may be deposited on a flat or slightly roughened surface of the conductive foil 28, which can be made of copper, aluminum, silver, platinum, palladium, or silver-palladium, etc. A protective coating 29, which may be an insulative resin or ceramic material, such as epoxy resin, polyimide, bismeleimide triazine, cyanate ester, aluminum oxide, glass and the like, is deposited and fully covers said soft magnetic film 27. If said protective coating 29 is made of resin, which is preferably partial crosslinked before the lamination process. The component-carrying conductive foil 30, which comprises said conductive foil 28 carrying said soft magnetic film 27, is then laminated onto a unit circuit sheet 31 using an insulative sheet 32 as adhesive, illustrated in FIG. 7. The alignment must be carefully controlled during this lamination step. Said unit circuit sheet 31 comprises an insulative layer 33 made of an epoxy resin, polyimide, bismeleimide triazine, cyanate ester, polybenzocyclobutene and the like, covered with a patterned thin conductive layer 34 made of a conductive material, such as metal, conductive polymer, hardened metal paste or hardened carbon paste, etc. Said insulative sheet 32 may be a resin, such as epoxy resin, bismeleimide triazine, polyimide, or polybenzocyclobutene, etc., or organic material filled with fillers, such as fiber reinforced epoxy resin, particle silica filled epoxy resin, etc. The spiral coil 35, which may be a pattern of circular, elliptical, rectangular, polygonal spiral, or any other type of configuration, and circuit pattern 36 are made on said conductive layer 28. A conductive via 37 is formed to be one end of said spiral coil 35 while the other end 38 is directly formed on the same layer of said conductive foil 28, see also FIG. 8. Finally, a soft magnetic film 39 is deposited and covers said spiral coil 35 to further improve inductor performance if necessary.

Said soft magnetic material films 27 and 39 which are a magnetically soft material with the magnetic permeability greater than 1 may be made by sputtering, spin coating, roller coating or printing, etc. For instance, said soft magnetic film made of Mn—Zn ferrite, Ni—Mn—Zn ferrite, or magnetite etc. can be sputter-deposited while ferrite-resin paste, e.g. Mn—Zn ferrite powders dispersed in an epoxy resin, can be deposited by the printing method. However, the printed film should be hardened in place by heating before the deposition of said protective coating 29.

In accordance with the present invention, as illustrated in FIG. 3, the soft magnetic film 27 may also be deposited on a conductive foil 12 with a matte surface 13 and a surface 14, which may be either matte or flat. The less rough area 15, where the soft magnetic film 27 will be deposited, should be created, e.g. by a photoresist-microetching process or polishing process. In such a case, said less rough area 15 can be used to create the more precise soft magnetic film 27 and spiral coil 35 having the predetermined values and further maintain a sufficient adhesion between the soft magnetic film 27 and said conductive foil 12 simultaneously. In addition, said protective coating 29 will be unnecessary because the surface roughening step for enhancing adhesion between the soft magnetic film and said conductive foil 12 can be skipped.

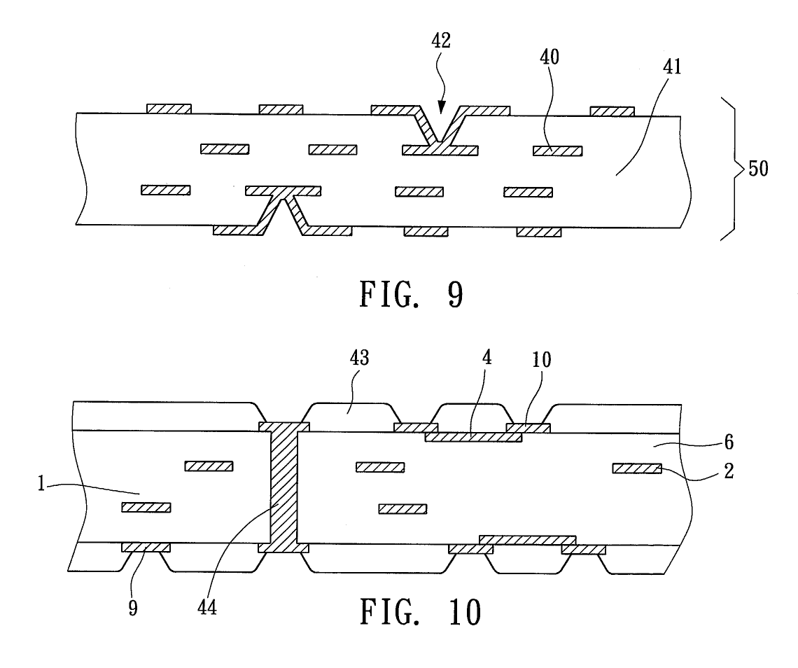

In accordance with the present invention, aforementioned unit circuit sheet 7, 21 or 31 is not limited to a single or two layer circuit sheet. Said unit circuit sheet 7, 21 or 31 can also be a multilayer circuit sheet bearing at least a circuit layer on its surface. As shown in FIG. 9, a typical four-layer unit circuit sheet 39 is illustrated, in which said circuit layers 40 are separated by the organic insulative layers 41. Also, as can be seen, two circuit layers can be electrically interconnected by the via 42, which is well known in the art. In accordance with a preferred embodiment of the present invention, when said embedded passive components are formed in the outmost layer(s), a protective layer (e.g. so-called solder mask layer) may be deposited on the surface circuit layer(s) to protect circuitry and provide insulation. Said protective layer may be made by organic material, or particle-filled organic material etc., such as epoxy resin, silica filled epoxy resin and the like. As shown in FIG. 10, a protective layer 43 is deposited on the circuit layer 10 after said lamination process. Also, as can be seen, four circuit layers are electrically interconnected by a conductive through-hole 44, which is well known in the art.

While novel features of the present invention have been described with reference to one or more particular embodiments herein, those skilled in the art will recognize that many modifications and variations of the present invention are possible. Therefore, the scope of the present invention should be limited only by the following claims.

1. A lamination method of embedding passive components in organic circuit board, comprising the steps of:
(a) forming a resistive film on a surface of an electrically conductive foil;
(b) laminating said conductive foil carrying said resistive film onto a unit circuit sheet using an insulative sheet as adhesive;
(c) forming the electrodes for said resistive film on said conductive foil.

2. The methods in claims 1, wherein said unit circuit sheet comprises at least one insulative layer, and a patterned conductive layer covering at least one side of said unit circuit sheet.

3. The method of claim 2, wherein said insulative layer is made of an insulative material selected from a group of organic material and organic material filled with the fillers.

4. The methods of claims 1 wherein said insulative sheet is made of an electrically insulative material selected from a group of organic material and organic material filled with the fillers.

5. The method of claim 1, wherein said resistive film is made of a material with a sheet resistance greater than 0.1 ohm/square.

6. A lamination method of embedding passive components in organic circuit board, comprising the steps of:
(a) forming a capacitive film on a surface of an electrically conductive foil;
(b) depositing a conductive layer which partial covers said capacitive film to be the lower electrode of said capacitive film;
(c) laminating said conductive foil carrying said capacitive film onto a unit circuit sheet using an insulative sheet as adhesive;
(d) forming the upper electrodes for said capacitive film on said conductive foil.

7. The methods in claims 6, wherein said unit circuit sheet comprises at least one insulative layer, and a patterned conductive layer covering at least one side of said unit circuit sheet.

8. The method of claim 7, wherein said insulative layer is made of an insulative material selected from a group of organic material and organic material filled with the fillers.

9. The methods of claims 6, wherein said insulative sheet is made of an electrically insulative material selected from a group of organic material and organic material filled with the fillers.

10. The method of claim 6, wherein said capacitive film is made of a material with a dielectric constant greater than 5.0.

11. A lamination method of embedding passive components in organic circuit board, comprising the steps of:
(a) forming a soft magnetic film on a surface of an electrically conductive foil;
(b) laminating said conductive foil carrying said soft magnetic film onto a unit circuit sheet using an insulative sheet as adhesive;
(c) forming the spiral coil being the inductive element and circuit pattern on said conductive foil;
(d) forming a conductive via to be an electric terminal of said spiral coil.

12. The methods in claims 11, wherein said unit circuit sheet comprises at least one insulative layer, and a patterned conductive layer covering at least one side of said unit circuit sheet.

13. The method of claim 12, wherein said insulative layer is made of an insulative material selected from a group of organic material and organic material filled with the fillers.

14. The methods of claims 11, wherein said insulative sheet is made of an electrically insulative material selected from a group of organic material and organic material filled with the fillers.

15. The method of claim 11, wherein said soft magnetic film is made of a magnetically soft material with a magnetic permeability greater than 1.
